(19) United States
(12) Patent Application Publication
(10) Pub. No.: US 2008/0041348 A1
(43) Pub. Date: Feb. 21, 2008

(54) FUEL TANK WITH INTEGRATED EVAPORATIVE EMISSIONS SYSTEM

(76) Inventors: Jeffrey P. Grant, Forest Hill, MD (US); John E. Buck, Cockeysville, MD (US); Dawei (David) Chen, Forest Hill, MD (US); Michael A. Nelson, Towson, MD (US)

Correspondence Address: THE BLACK & DECKER CORPORATION, 701 EAST JOPPA ROAD, TW199, TOWSON, MD, 21286, US

(21) Appl. No.: 11/734,469

(22) Filed: Apr. 12, 2007

Related U.S. Application Data
(60) Provisional application No. 60/791,324, filed on Apr. 12, 2006.

(51) Int. Cl. F02M 25/08

(52) U.S. Cl. 123/519

(57) ABSTRACT

An evaporative emissions fuel system for a general-purpose engine includes a fuel tank with a valve assembly located within the fuel tank for guiding fuel vapor to a canister. The canister contains activated charcoal to treat the fuel vapor and guide the vapor to a carburetor which burns the fuel vapor and hydrocarbons. The valve assembly has a valve opening for receiving the fuel vapor and a float responsive to the fuel within the tank for sealing the valve opening when the fuel within the tank is at a feel level capable of entering the valve opening.

This application claims the benefit of U.S. Provisional Patent Application 60/791,324 filed on Apr. 12, 2006, the entirety of which is incorporated herein by reference. This application includes material which is subject to copyright protection. The copyright owner has no objection to the facsimile reproduction by anyone of the patent disclosure, as it appears in the Patent and Trademark Office files or records, bat otherwise reserves all copyright rights whatsoever.

### FIELD OF THE INVENTION

The present invention relates to the field of fuel vapor emissions systems for engines and more particularly to a fuel tank assembly for controlling evaporative emissions.

### BACKGROUND OF THE INVENTION

Evaporative emissions systems and the use of carbon or charcoal canisters have been used in combination with automotive engines and fuel tanks. However, new regulations have propelled the need for evaporative emissions control systems for small utility engines. Typically, these small utility engines and their associated gas tank have confined locations and dimensions forcing most of the components and lines of an evaporative emissions system to be exposed. Such exposure is both unsightly and problematic as such valves, components and lines are subject to damage.

A typical emission control system 100, as seen in FIG. 1A, for a small utility engine consists of a fuel tank 102 which stores a fuel 104, such as gasoline, and mates with a sealed cap 108. The fuel tank 102 contains fuel which during operation of the engine is fed through hue 118 to a carburetor 120. The flow of fuel along line 118 may be controlled by a feel shutoff valve (not shown). Attached to the tank 102 is a valve 105, such as a slant valve, which allows emission vapors to escape the tank 102, as pressure in the tank 102 increases, to a charcoal canister 125 through line 107. The charcoal, canister 125 receives and treats the evaporative emissions. Upon starting the utility engine, suction is created drawing outside air in through vent 122 and thus purging the charcoal of the accumulated hydrocarbons and pulling the evaporative emissions within the charcoal canister 125 through line 124 into carburetor 120 where the evaporative emissions and hydrocarbons can be burned. After the engine is shut off the charcoal canister 125 continues to receive and treat the evaporative emissions from tank 102 until the engine is started again and the evaporative emissions and hydrocarbons are purged from the canister 125, drawn into and burned by carburetor 120.

As seen in FIG. 1B, a generator 101 is depicted which incorporates a known evaporative emissions system which exposes the valve 105 and the evaporative emissions line 107 leading to charcoal canister 125. On or near the top surface of the fuel tank 102 is an opening 110 for receiving a sealed cap. Additionally, valve 105 mates with fuel tank 102 at a position on a top surface of the fuel tank 102. The valve 105 is exposed creating an unsightly appearance for industrial design as well as exposing the valve 1.05 to possible damage. Further, the evaporative emissions line 107 runs along the top, down the side and along the end of fuel tank 102 before traveling down, the frame 103 of she generator 101 before finally connecting to canister 125. Both the valve 105 and line 107 are susceptible to damage and create an unsightly appearance.

Therefore, what is needed is an evaporative emissions system which provides a compact, cost effective and easy to manufacture design while reducing the unsightly appearance and exposure of the evaporative emissions valve and lines.

### SUMMARY OF INVENTION

The present invention provides an evaporative emissions fuel system for a general-purpose engine which overcomes the obstacles described above by providing a system with a fuel tank, a canister which absorbs fuel vapor from the fuel tank, a carburetor communicating with the fuel vapor from the canister and communicating with the fuel from the fuel tank; a valve assembly located within the fuel tank for receiving the fuel vapor from within the fuel tank and communicating the fuel vapor to the canister; and the valve assembly comprising a valve opening for receiving fuel vapor and a float responsive to the fuel within the tank for sealing the valve opening when the fuel within the tank is at a fuel level capable of entering the valve opening. The valve opening may be located above a max fuel level of the fuel tank and below a top interior surface of the fuel tank. The Post may be attached to a sealing element which seals the valve opening. The evaporative emissions fuel system may also comprise a valve assembly brace attached to an interior surface of the tank and to the valve assembly.

Another aspect of the present invention provides a fuel tank assembly for a general-purpose engine comprising; a closed fuel tank having an inlet to the interior of the tank, a fuel outlet, and a fuel vapor outlet; an unvented fuel cap receivable on the inlet for sealing the closed fuel tank; a valve assembly located within the fuel tank for receiving fuel vapor from inside the fuel tank and communicating the fuel vapor through the fuel vapor outlet to a canister which absorbs and treats fuel vapor; a carburetor communicating with the fuel vapor from the canister and communicating with the fuel from the fuel tank through the fuel outlet; and the valve assembly comprising a valve opening for receiving fuel vapor and a float responsive to the fuel within the tank for sealing the valve opening when the fuel within the tank is at a fuel level, capable of entering the valve opening. Further, the valve opening may be located above a max fuel level of the fuel tank and below a top interior surface of the fuel tank. The float may be attached to a sealing element which seals the valve opening. Additionally, a valve assembly brace may be attached to an interior surface of the tank and to the valve assembly.

### BRIEF DESCRIPTION OF DRAWINGS

FIG. 1A is a schematic view of a known fuel tank and exposed evaporative emissions system;

FIG. 1B is a side elevation view of a generator incorporating a known and exposed evaporative emissions system;

FIG. 2 is a schematic view of a fuel tank and evaporative emissions system of the present invention;

FIG. 3 is a sectional side view of an evaporative emissions valve of the evaporative emissions system of the present invention;

FIG. 4A is a front view of an alternative evaporative emissions valve which could be incorporated in the evaporative emissions system of the present invention;

FIG. 4B is a side view of the alternative evaporative emissions valve depicted in FIG. 4A; and

FIG. 5 is a front view of an alternative evaporative emissions valve which could be incorporated in the evaporative emissions system of the present invention.

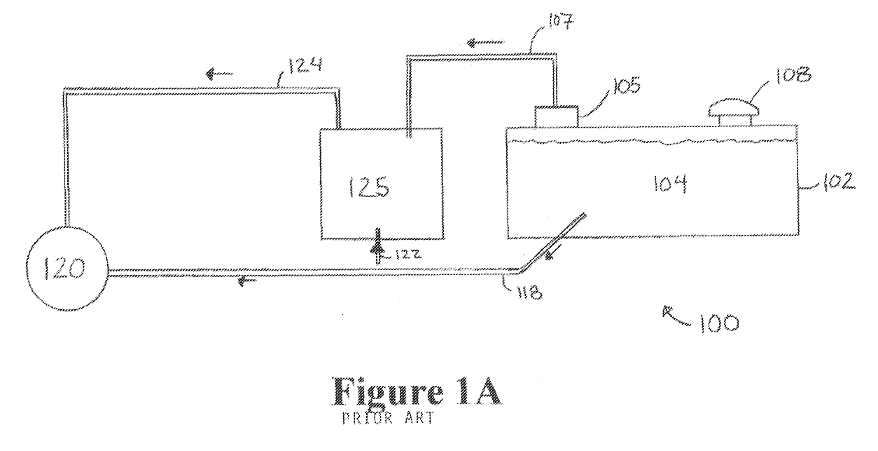

### DETAILED DESCRIPTION

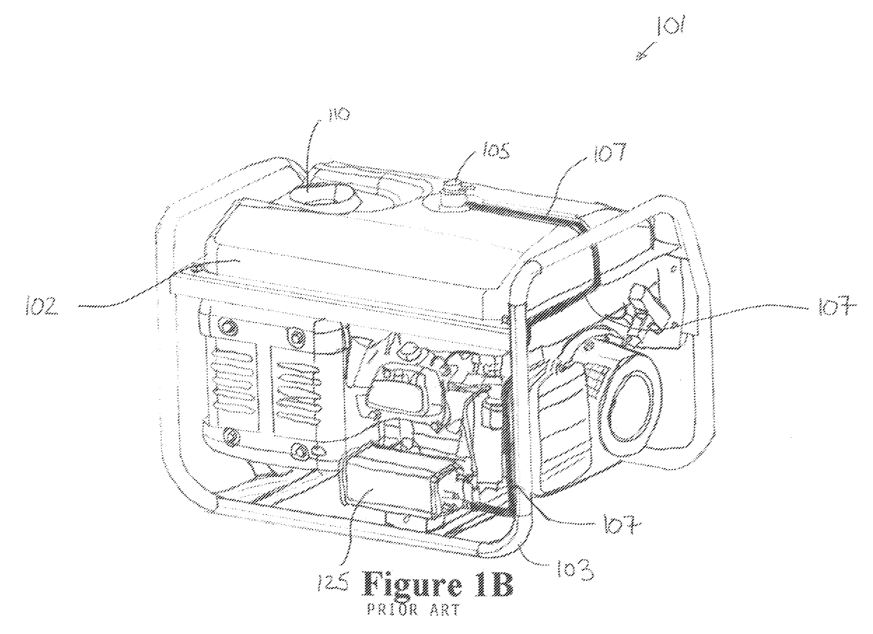

The system of the present invention will now be described in conjunction with FIGS. 2-5. The present invention provides an evaporative emissions system which overcomes the obstacles described above by providing an evaporative emissions system which integrates the evaporative emissions valve and all or portions of the emissions flow line within the internal chamber of the fuel tank.

As seen in FIG. 2, the evaporative emissions system 200 of the present invention includes a gas tank 202 which is used to house or contain a fuel 204 such as gasoline. The fuel tank 202 mates with a fill cap 208 which seals the emissions vapors and fuel within the fuel tank 202. The cap 208 mates with a cap mating structure 210 which is also used to support a fuel filter or screen 209. Fuel exits the tank 202 from an exit location 214 such as a welded pipe fitting or threaded sealed fitting. A threaded sealed fitting 214 is depicted in FIG. 2 which also includes a brass fitting 216 which connects the exit 214 to a fuel shutoff valve 212. A fluid passage line 218 connects the fuel shutoff valve 212 to carburetor 220, During engine (not shown) operation, fuel is drawn from tank 202 through the fuel shutoff valve 212 and line 218 to carburetor 220.

When the engine is not in operation, external temperatures on the fuel, tank 202 can cause an increase of the fuel 204 temperature within the tank 202 causing an increase in vapor pressure within the tank 202. Historically, this increased vapor pressure was simply released through vent holes in the cap. However, new emissions regulations do not allow untreated vapor pressure to be released into the atmosphere. Therefore, the vapor emissions system of the present invention cheers the vapor pressure in the fuel, tank 202 through a charcoal treatment section or canister 225. In the present invention, the vapor pressure is directed to a charcoal treatment canister or chamber 225 through a fuel tank valve assembly 230. The canister 225 typically uses activated carbon to treat the fuel vapor by removing the hydrocarbons. Once the engine is started the hydrocarbons from within the canister 225 are pulled into the carburetor 220 and burned.

The fuel tank emissions valve assembly 230 is located inside the tank and includes a top portion 232 and an emissions line 233. The emissions vapor exits the tank 202 from an exit location 236 such as a welded pipe fitting or threaded sealed fitting, A threaded sealed lining 234 is depleted hi FIG. 2 which also includes a brass fitting 236 which connects the exit 234 to an emissions line 238 through connection 237. The emissions vapors are drawn into the top portion 232 of the valve assembly 230 and are then passed through lines 233 and 238 into canister 225 where the vapors are treated.

The top portion 232 of the emissions valve assembly 230 may be secured to the inside top or side surface of tank 202, Additionally, or as an alternative, the emissions line 233 may be secured to a bracket 235, such as through welding or placement in a grommet, where the bracket is secured to die inside of the tank 202. Securing the top 232 of the valve assembly 230 or securing the emissions line 233 prevents the emissions valve assembly 230 from significant movement thereby preventing or minimizing the emissions valve assembly 230 from becoming damaged. Still further, line or tube 233 may be a metal piping or some form of tubing which may be sealed or secured to the bottom of tank 202 through use of welding, a grommet or some other fitting.

When the engine is not running, pressure in the tank 202 will be released as the emissions vapor flows from the top portion 232 of the valve assembly 230 down the emissions line 233, exits the tank 202 at the emissions exit 234 and flows into the canister 225 though line 238. Once in the chamber 225, the evaporate emissions vapor is treated. Upon starting the utility engine, suction is created drawing outside air through vent 222 and pulling the evaporative emissions within the charcoal canister 225 through line 224 into carburetor 220 where the evaporative emissions and hydrocarbons can be burned. During operation of the engine, emissions vapor can also be drawn into the emission valve assembly 230, through treatment canister 225, and into carburetor 220 where the emissions will be burned. Once the engine is shut off the suction pulling air through dm charcoal canister 225 is removed and the canister 225 is set to receive and treat the evaporative emissions within tank 202 until the engine is started again and the evaporative emissions can be drawn into and burned by carburetor 220.

As fuel 204 is added to tank 202 the fuel 204 will reach or obtain a max fuel level 206. Exceeding the max fuel level 206 would cause fuel 204 to overflow from tank 202. The present invention incorporates a design to prevent fuel 204 from entering the vapor emissions valve assembly 230 by sizing the valve assembly 230 so that the top portion 232 of the valve assembly 230 is above the max fuel level 206. Specifically, the valve assembly 230 is sized so that a valve opening for receiving emissions vapor is located above the max fuel level 206 but below the top interior surface 207 of the tank 202. The valve opening is located within the top portion 232 of the valve assembly 230. By having the valve opening above the max fuel level 206 the opening is positioned in area 205 where vapor pressure resides but above the max fuel level 306 so that fuel does not easily flow into the emissions vapor valve assembly 230 or line 233. Proper sizing of the valve assembly 230 may require sizing of both the valve assembly 230 and fuel tank 202.

As shown in FIG. 2, the tank 202 provides at least one high section or vapor area 205 which allows the top portion 232 of valve assembly 230 to reside between the max fuel level 206 and the top interior surface 207 of the fuel tank 202. The distance between the top interior surface 207 and the max fuel level 200 has some height “h” as shown in FIG. 2. Understandably, Par shipping, storage, and material costs there is a benefit to minimizing the height “h” while still allowing enough space to properly place the valve opening within the top portion 232 of valve assembly 230 within area 205. In a preferred embodiment, the height “h” is about 10 millimeters but could be as small as 1-2 millimeters and as largo as the industrial design of the tank will allow. However, it is unlikely that most tanks 202 would have an area 205 height “h” above several hundred millimeters.

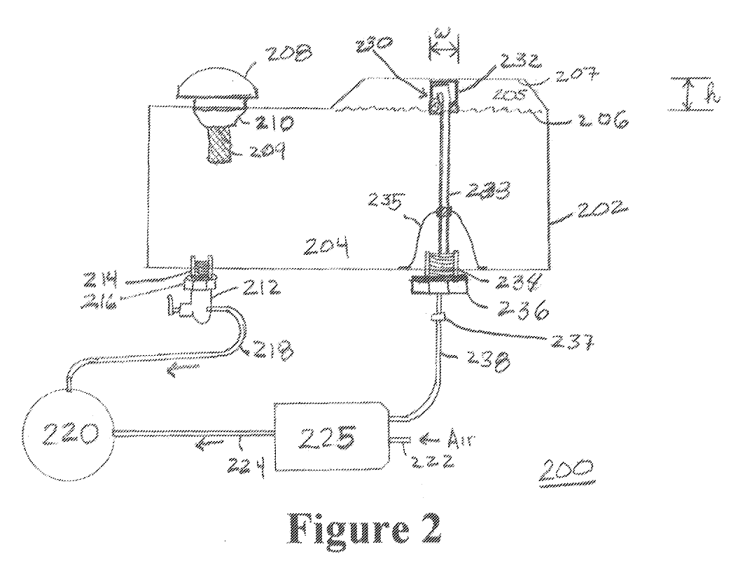

FIG. 3 provides a more detailed view of the top portion 332 of the emissions valve assembly 330 for an exemplary embodiment. The top portion 232 of valve assembly 330 may be connected to, in contact with or in close proximity to a top interior surface 307 of the fuel tank 202. The emissions valve assembly 330 may be a roll over or snorkel type valve which is comprised of a ball 340 or other float like device which is responsive to the fuel level 306. Fuel is allowed to enter the valve chamber 346 through the chamber holes 342. As the fluid level rises, such as might happen when the unit is being moved or tilted, the bid level in chamber 346 will rise causing the float ball 340 to rise until it contacts tapered surface 348. A seal is created when the float ball 340 contacts the tapered surface 348 preventing the fuel from entering line 333.

Under normal conditions, the float bad 340 rest on the top of the fluid surface level 306 within chamber 346 at some distance from the tapered surface 348. The evaporative emissions are able to enter the chamber 346 from the top chamber holes 342 and flow through line 333 to the charcoal canister. The top portion 332 of the valve assembly 330 should be sized such that height “h” provides enough space to allow the evaporative emissions to escape when the float ball 340 is resting on the surface of the max fuel level 306.

As seen in FIGS. 2 and 3, another aspect of the top portion 332 of the valve assembly 330 may be the width “w” of the top portion 332. In one exemplary embodiment, the tank 202 will have already been constructed with an opening located on the bottom, of tank 202 for receiving the valve assembly 230. The opening is sized to properly receive an appropriately sized grommet or threaded fitting 234 to properly fasten and seal the valve assembly 230 to the tank 202. After the tank 202 is assembled, the entire valve assembly 330 would be inserted into the opening. Therefore, the width “w” of the valve assembly 330 must be smaller then the width or diameter of the cutout or opening on the bottom of fuel tank 202. One advantage of a valve assembly 330 properly sized for insertion, into an opening would be ease of removal of the valve assembly 230 for service or replacement. The valve assembly 330 or the top portion 332 could include bends or sections enabling the total, width “w” of the valve assembly 230 to be wider than the opening but no one point could be larger than the opening. Further, the opening need not be on the bottom or underside of tank 202 and could be located in various other locations on tank 202.

Additionally, all or a portion of valve assembly 230 could be placed in the tank 202 prior to complete assembly of the tank 202. In one exemplary embodiment, the top portion 232 of the valve assembly 230 is fastened to the top surface 202 of the fuel tank 202. The line 233 might also be fastened to a bracket 235 to support the valve assembly 330, Finally the two halves of the tank 202 would be mated and sealed together to from the tank 202 with all or a portion of the valve assembly 230 already in tank 202. The valve assembly or vapor exit 234 could be a welded fitting, grommet or threaded fitting to properly seal the vapor exit 234 from tank 202, In addition to metal, the tank 202 could also be constructed using a conventional blow molded plastic technique, or other known techniques, enabling proper sizing and fitting of the tank 202 for interaction with the valve assembly 230.

Tank 202 would likely have a generally flat bottom, a generally flat top with a recessed opening 210 for cap 208. The opening 210 for cap 208 would be lower than the highest point on the top surface of tank 202. The integral design of the fuel vapor valve assembly 230 located within the tank 202 allows for the top surface of the tank to be clean and free from valves and lines. The tank 202 would also have four sidewalk any or all of which may be inclined or configured with a unique shape as required for a particular application.

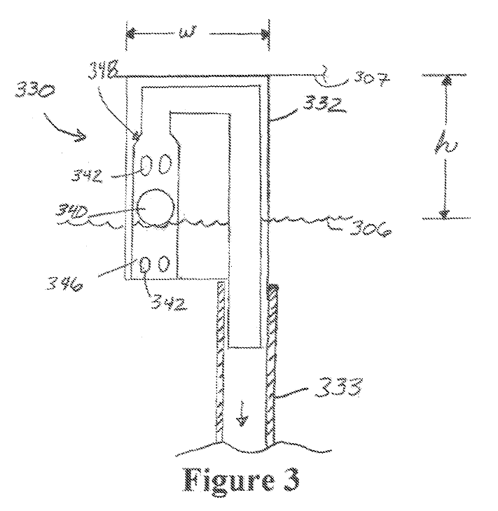

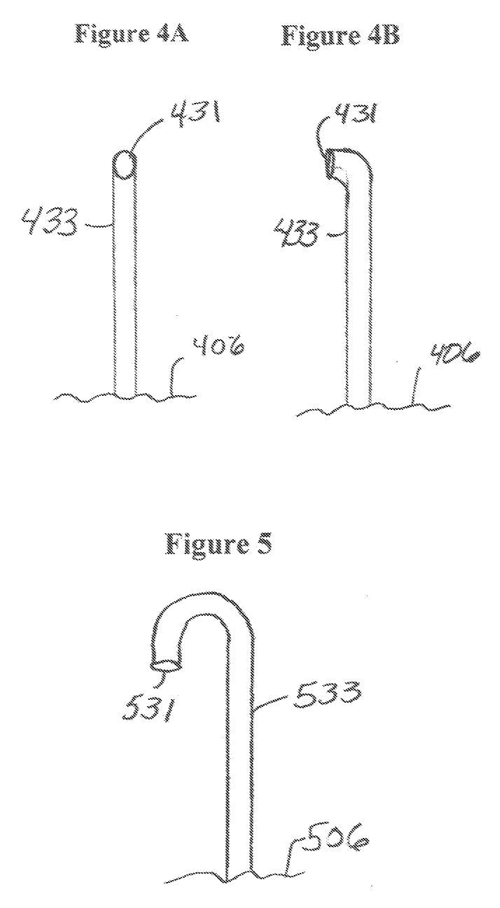

In addition to the snorkel or hall float valve depicted in FIG. 3, the evaporative emissions system of the present invention could use alternative valve assembly designs. As seen in FIGS. 4A and 4B, a simple angled and open tube 433 could be used where the opening 431 resides above the max fuel level 406. FIG. 4B is a side elevation view of the hoe or tube 433 depicted in FIG. 4A. FIG. 5 provides an additional evaporative emissions system with an inverse “J” or ISO degree bend at the top of tube 533 such that the opening 531 is below die maximum height of tube 533. The designs depicted in FIGS. 4A, 4B, and 5 do not create a seal preventing fuel from entering the line 433, 533 when the unit with the fuel tank 202 is tilted, slanted or moved. However, experimentation has shown that even with openings 431, 531 of a small diameter that very little fuel is allowed to pass through tubes 433, 533 even with vigorous sloshing. Still further, the evaporative emissions system 200 and the charcoal filter canister 225 can handle some fuel entering the canister 225 as it will eventually evaporate, be treated, and burned by the carburetor 220.

Still further, the evaporative emissions system of the present invention could use a valve assembly which comprises a much larger float device not within a defined valve assembly chamber. The large float would be connected or attached to the valve assembly and could have a sealing element connected or incorporated into the float design to provide a seal against the opening in the valve assembly leading to the vapor passage path or line.

The present invention provides an internal evaporative emissions valve assembly which is responsive to the fuel level with the fuel tank. Further, the top portion of the fuel valve assembly, and specifically the opening in the valve assembly for receiving the fuel vapor, is positioned such that the valve assembly opening is above the max fuel level of the tank but below the interior top surface of the fuel tank.

Although a preferred embodiment and exemplary embodiments of dm present invention has been described in detail the present invention is not limited to the embodiments described herein and can be modified in a variety of ways without departing from the spirit and scope of the present invention.

We claim:

1. An evaporative emissions fuel system for a general-purpose engine comprising;
a fuel tank;
a canister which absorbs fuel vapor from the fuel tank;
a carburetor communicating with the feel vapor from the canister and communicating with fuel from the fuel tank;
a valve assembly located within the fuel tank for receiving the fuel vapor within the fuel tank and communicating the fuel vapor to the canister; and
the valve assembly composing a valve opening for receiving fuel vapor and a float responsive to the fuel within the tank for sealing the valve opening when the fuel within the tank reaches a predetermined level.

2. The evaporative emissions system of claim 1, wherein the valve opening is located above a max fuel level of the fuel tank and below a top interior surface of the fuel lank.

3. The evaporative emissions fuel system of claim 1, wherein the float is attached to a sealing element which seals the valve opening.

4. The evaporative emissions fuel system of claim 1, further comprising a valve assembly brace attached to an interior surface of the tank and to the valve assembly.

5. A fuel tank assembly for a general-purpose engine comprising;
a closed fuel tank having au inlet to use interior of the tank, a fuel outlet and a fuel vapor outlet;
an unvented fuel cap receivable on the inlet for sealing the closed fuel tank;
a valve assembly located within the fuel tank for receiving feel vapor inside the feel tank and communicating the fuel vapor through fee fuel vapor outlet to a canister which absorbs fuel vapor;
a carburetor communicating with the fuel vapor from the canister and communicating with fuel from the fuel tank through the fuel outlet; and
the valve assembly comprising a valve opening for receiving fuel vapor and a float responsive to the feel within the tank for sealing the valve opening when the fuel within the tank is at a fuel level capable of entering the valve opening.

6. The fuel tank assembly of claim 5, wherein the valve opening is located above a max fuel level of the fuel tank and below a top interior surface of the fuel tank.

7. The fuel tank assembly of claim 5, wherein the float is attached to a sealing element which seals the valve opening.

8. The feel tank assembly of claim 5, further comprising a valve assembly brace attached to an interior surface of the tank and to the valve assembly.
